(19) United States
(12) Patent Application Publication
(10) Pub. No.: US 2026/0200594 A1
(43) Pub. Date: Jul. 16, 2026

(54) AIRCRAFT CABLE MOORING DEVICE AND FIXING METHOD

(71) Applicant: LOONG (HANGZHOU) AVIATION MAINTENNACE ENGINEERING CO., LTD, Hangzhou, Zhejiang (CN)

(72) Inventors: Kang ZENG, Hangzhou, Zhejiang (CN); Jikai FENG, Hangzhou, Zhejiang (CN); Suili YANG, Hangzhou, Zhejiang (CN); Wei YANG, Hangzhou, Zhejiang (CN); Qiang LIU, Hangzhou, Zhejiang (CN); Ye JING, Hangzhou, Zhejiang (CN); Jiansheng GENG, Hangzhou, Zhejiang (CN); Limin ZHOU, Hangzhou, Zhejiang (CN)

(73) Assignee: LOONG (HANGZHOU) AVIATION MAINTENNACE ENGINEERING CO., LTD, Hangzhou, Zhejiang (CN)

(21) Appl. No.: 19/138,609

(22) PCT Filed: Mar. 29, 2024
(86) PCT No.: PCT/CN2024/084743

§ 371 Date: Jun. 12, 2025

(30) Foreign Application Priority Data
Oct. 18, 2023 (CN) 202311355651.8

(51) Int. Cl. B64F 1/16; B64F 5/40

(52) U.S. Cl. CPC B64F 1/16; B64F 5/40

(57) ABSTRACT

The present disclosure provides an aviation rope tethering device and a fixing method. The aviation rope tethering device includes a ground anchor assembly, a connecting assembly and a rope unit. The ground anchor assembly is used for installation on the ground of an airport; the connecting assembly includes a connecting column having multiple rope binding positions spaced apart in a length direction of the connecting column, one end of the connecting column being used to connect to one of an airport mobile maintenance workstation, an aviation trailer and an aircraft; and the rope unit is connected to at least one of the rope binding positions, the connecting column being connected to the ground anchor assembly through the rope unit. In the aviation rope tethering device provided by the present disclosure, by installing a connecting column at the bottom of the airport mobile maintenance workstation, placing a ground anchor assembly on the ground, and then connecting and fixing the connecting column to the ground anchor assembly through a rope unit, the airport mobile maintenance workstation can be fixed in the working position, making it not easily affected by wind to move accidentally, reducing the situation of the airport mobile maintenance workstation accidentally sliding toward the aircraft or other facilities, and improving the safety of the use of the airport mobile maintenance workstation.

### TECHNICAL FIELD

The present disclosure relates to the technical field of airport maintenance, and in particular to an aviation rope tethering device and a fixing method.

### BACKGROUND

This section only provides background information related to the present disclosure, which is not necessarily the prior art.

The aircraft route maintenance site, as the busiest grass-root unit for providing operational support for transportation airlines, is also the most important “defense line” for providing operational support for ground safety. Air route maintenance has the characteristics of high maintenance frequency, limited maintenance time, high safety and quality requirements, and harsh environment. Existing mobile workstations are prone to accidental displacement due to the influence of wind and ground tilt during operation, causing safety hazards.

### SUMMARY

An object of the present disclosure is to at least solve the problem that one of the existing airport mobile maintenance workstation, aviation trailer and aircraft is prone to accidental displacement during operation. This object is achieved through the following technical solutions.

A first aspect of the present disclosure provides an aviation rope tethering device, which includes:
a ground anchor assembly, which is used for installation on the ground of an airport;
a connecting assembly, which includes a connecting column having multiple rope binding positions spaced apart in a length direction of the connecting column, one end of the connecting column being used to connect to one of an airport mobile maintenance workstation, an aviation trailer and an aircraft; and
a rope unit, which is connected to at least one of the rope binding positions, the connecting column being connected to the ground anchor assembly through the rope unit.

The aviation rope tethering device provided by the present disclosure is applied to fixation of one of the airport mobile maintenance workstation, the aviation trailer, and the aircraft. Taking the airport mobile maintenance workstation as an example, by installing a connecting column at the bottom of the airport mobile maintenance workstation, placing a ground anchor assembly on the ground, and then connecting and fixing the connecting column to the ground anchor assembly through a rope unit, the airport mobile maintenance workstation can be fixed in the working position, making it not easily affected by wind to move accidentally, reducing the situation of the airport mobile maintenance workstation accidentally sliding toward the aircraft or other facilities, and improving the safety of the use of the airport mobile maintenance workstation.

In addition, the aviation rope tethering device according to the present disclosure may also have the following additional technical features.

In some embodiments of the present disclosure, the ground anchor assembly includes four fixed rings distributed in a rectangular shape, two of which are provided on one side of the connecting column in a horizontal direction, and the other two of which are provided on the other side of the connecting column in the horizontal direction.

In some embodiments of the present disclosure, the connecting column extends in a height direction of the airport mobile maintenance workstation, and the connecting assembly further includes multiple cross bars spaced apart on the connecting column; two ends of the cross bars extend in a direction away from the connecting column, and the rope binding positions are formed at the connection points between the cross bars and the connecting column.

In some embodiments of the present disclosure, the rope unit includes a first tethering rope, a second tethering rope, and four third tethering ropes; two ends of the first tethering rope are respectively connected to two of the rope binding positions, and between the two ends of the first tethering rope, the first tethering rope is connected to two of the fixed rings respectively through two of the third tethering ropes; two ends of the second tethering rope are respectively connected to two of the rope binding positions, and between the two ends of the second tethering rope, the second tethering rope is connected to the other two fixed rings respectively through the other two third tethering ropes.

In some embodiments of the present disclosure, the rope unit further includes two fourth tethering assemblies, each of which includes a fourth tethering rope and two connecting rings; two ends of the fourth tethering rope are respectively connected to one of the connecting rings; the first tethering rope passes through the two connecting rings of one of the fourth tethering assemblies respectively, and the two third tethering ropes are respectively connected to one of the connecting rings; the second tethering rope passes through the two connecting rings of the other one of the fourth tethering assemblies respectively, and the two third tethering ropes are respectively connected to one of the connecting rings.

In some embodiments of the present disclosure, the number of the cross bars is two; the two ends of the first tethering rope are respectively wrapped around the two cross bars, and the two ends of the first tethering rope are also wrapped around the connecting column; the two ends of the second tethering rope are respectively wrapped around the two cross bars, and the two ends of the second tethering rope are also wrapped around the connecting column.

In some embodiments of the present disclosure, at least one of the first tethering rope, the second tethering rope, the third tethering rope and the fourth tethering rope is provided with an adjusting member for adjusting the tensioning degree of the tethering rope.

In some embodiments of the present disclosure, the airport mobile maintenance workstation further includes a support device, which is connected to a bottom end of the connecting column, and which is used to support one of the airport mobile maintenance workstation, the aviation trailer, and the aircraft.

In some embodiments of the present disclosure, a support height of the support device is adjustable.

A second aspect of the present disclosure provides a fixing method for an airport mobile maintenance workstation, which includes the following steps:
installing a ground anchor assembly on the ground of an airport;
installing a connecting assembly at a bottom end of the airport mobile maintenance workstation, the connecting assembly having multiple rope binding positions arranged in a cross shape; and
wrapping two ends of tethering ropes around the multiple rope binding positions and the ground anchor assembly respectively to fix the airport mobile maintenance workstation.

The tethering method proposed in the second aspect of the present disclosure can anchor one of the airport mobile maintenance workstation, the aviation trailer and the aircraft to the ground of the airport. This tethering method requires a simple structure, has a low cost, and can be quickly implemented. Taking the airport mobile maintenance workstation as an example, after the airport mobile maintenance workstation is moved into place, the staff can fix the position of the airport mobile maintenance workstation through this tethering method, reducing the accidental movement of the airport mobile maintenance workstation caused by wind or other external factors, and improving the safety of the use of the airport mobile maintenance workstation.

### BRIEF DESCRIPTION OF THE DRAWINGS

Upon reading the detailed description of the preferred embodiments below, various other advantages and benefits will become clear to those skilled in the art. The accompanying drawings are only used for the purpose of illustrating preferred embodiments, and should not be considered as a limitation to the present disclosure Moreover, throughout the drawings, the same reference signs are used to denote the same components. In the drawings:

FIG. 1 shows a schematic diagram of the structure of an airport mobile maintenance workstation according to an embodiment of the present disclosure (the structure of tethering rope is only schematic); and

FIG. 2 shows a schematic diagram of the structure of an aviation rope tethering device according to an embodiment of the present disclosure.

### LIST OF REFERENCE SIGNS

100: airport mobile maintenance workstation;
10: wheel device; 11: trailer device;
200: aviation rope tethering device; 20: connecting column; 21: cross bar; 22: first tethering rope; 23: second tethering rope; 24: third tethering rope; 25: fourth tethering rope; 26: fixed ring; 27: connecting ring; 28: adjusting member;
30: support device.

### DETAILED DESCRIPTION

Hereinafter, exemplary embodiments of the present disclosure will be described in greater detail with reference to the accompanying drawings. Although the exemplary embodiments of the present disclosure are shown in the drawings, it should be understood that the present disclosure may be implemented in various forms and should not be limited by the embodiments set forth herein. On the contrary, these embodiments are provided to enable a more thorough understanding of the present disclosure and to fully convey the scope of the present disclosure to those skilled in the art.

It should be understood that the terms used herein are only for the purpose of describing specific exemplary embodiments, and are not intended to be limitative. Unless clearly indicated otherwise in the context, singular forms “a”, “an”, and “said” as used herein may also mean that plural forms are included. Terms “include”, “comprise”, “contain” and “have” are inclusive, and therefore indicate the existence of the stated features, steps, operations, elements and/or components, but do not exclude the existence or addition of one or more other features, steps, operations, elements, components, and/or combinations thereof. The method steps, processes, and operations described herein should not be interpreted as requiring them to be executed in the specific order described or illustrated, unless the order of execution is clearly indicated. It should also be understood that additional or alternative steps may be used.

Although terms “first”, “second”, “third” and the like may be used herein to describe multiple elements, components, regions, layers and/or sections, these elements, components, regions, layers and/or sections should not be limited by these terms. These terms may only be used to distinguish one element, component, region, layer or section from another region, layer or section. Unless clearly indicated in the context, terms such as “first”, “second” and other numerical terms do not imply an order or sequence when they are used herein. Therefore, the first element, component, region, layer or section discussed below may be referred to as a second element, component, region, layer or section without departing from the teachings of the exemplary embodiments.

For ease of description, spatial relative terms may be used herein to describe the relationship of one element or feature relative to another element or feature as shown in the drawings. These relative terms are, for example, “inner”, “outer”, “inside”, “outside”, “below”, “under”, “above”, “over”, etc. These spatial relative terms are intended to include different orientations of the device in use or in operation in addition to the orientation depicted in the drawings. For example, if the device in the figure is turned over, then elements described as “below other elements or features” or “under other elements or features” will be oriented “above the other elements or features” or “over the other elements or features”. Thus, the exemplary term “below” may include orientations of both above and below. The device can be otherwise oriented (rotated by 90 degrees or in other directions), and the spatial relationship descriptors used herein will be explained accordingly.

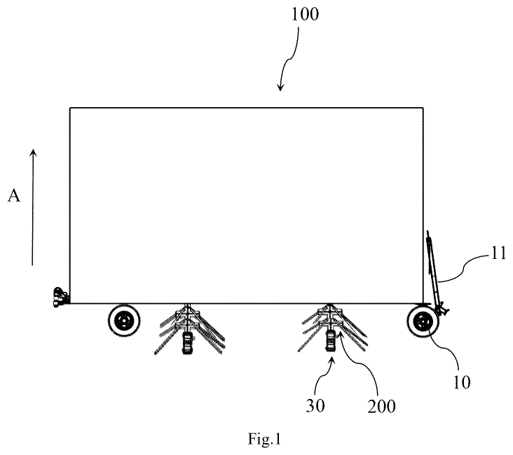

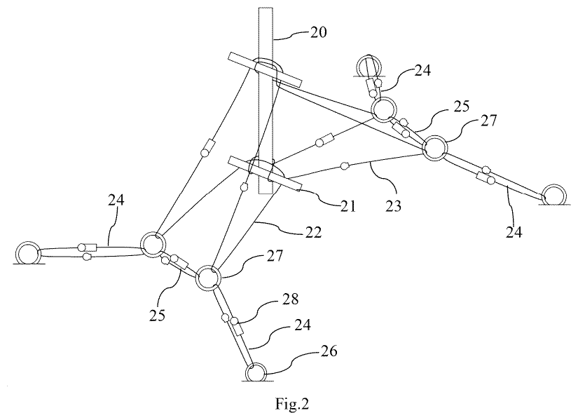

As shown in FIGS. 1 and 2, direction A in FIG. 1 indicates a height direction of an airport mobile maintenance workstation 100, and a first aspect of the present disclosure provides an aviation rope tethering device 200, which includes:
a ground anchor assembly, which is used for installation on the ground of an airport;
a connecting assembly, which includes a connecting column 20 having multiple rope binding positions spaced apart in a length direction of the connecting column 20, one end of the connecting column 20 being used to connect to one of an airport mobile maintenance workstation, an aviation trailer and an aircraft; and
a rope unit, which is connected to at least one of the rope binding positions, the connecting column 20 being connected to the ground anchor assembly through the rope unit.

It can be understood that, taking the tethering of the airport mobile maintenance workstation as an example, the aviation rope tethering device 200 provided by the present disclosure fixes the airport mobile maintenance workstation to the ground of the airport by tethering. The ground anchor assembly can be multiple ground anchors fixedly installed on the ground of the airport. The ground anchors can be fixed on the ground of the airport through concrete, or installed on the ground through a detachable structure. The structure of the ground anchor can be a ring-like structure to facilitate tying a rope to the ground anchor. The position of the ground anchor assembly is set according to actual needs, such as in the working area of the airport mobile maintenance workstation. The connecting assembly is installed on the airport mobile maintenance workstation, and can be connected to the airport mobile maintenance workstation by welding or bolt fixing. The structure of the connecting assembly can be a cross-shaped structure for facilitating rope binding; for example, multiple cross bars 21 are arranged on a connecting column 20, and rope binding can be carried out through the cross-shaped structure. The connection points between the connecting column 20 and the cross bars 21 are the rope binding positions. The multiple rope binding positions are spaced apart in the length direction of the connecting column 20 to form multiple binding points in the height direction. In practical use, ropes can be used to bind the connecting assembly in multiple layers to improve the stability of the connection. The rope unit can be multiple tethering ropes, and the tethering ropes can be ring-like structures, i.e., two ends of a rope are connected. The ropes of the ring-like structure can be connected to the connecting column 20 by sleeving connection, which is easy to operate and has good connection reliability. The tethering rope can also be a structure in which the two ends of the rope are not connected. Tying the two ends of the tethering rope to the rope binding position and the ground anchor assembly respectively can also fix the airport mobile maintenance workstation.

The aviation rope tethering device 200 provided by the present disclosure is applied to fixation of one of the airport mobile maintenance workstation, the aviation trailer, and the aircraft. By installing the connecting column 200 at the bottom of the airport mobile maintenance workstation, placing the ground anchor assembly on the ground, and then connecting and fixing the connecting column 20 to the ground anchor assembly through the rope unit, the airport mobile maintenance workstation can be fixed in the working position, making it not easily affected by wind to move accidentally, reducing the situation of the airport mobile maintenance workstation accidentally sliding toward the aircraft or other facilities, and improving the safety of the use of the airport mobile maintenance workstation.

In some embodiments of the present disclosure, the ground anchor assembly includes four fixed rings 26, which are distributed in a rectangular shape. Two of the fixed rings 26 are arranged on one side of the connecting column 20 in the horizontal direction, and the other two of the fixed rings 26 are arranged on the other side of the connecting column 20 in the horizontal direction.

It can be understood that the fixed ring 26 is a circular ring structure or another ring-like structure. The fixed ring 26 can be a closed ring-like structure, or a mechanism for providing an opening and closing the opening can be arranged on the fixed ring 26 to facilitate sleeving the tethering rope onto the fixed ring 26. The fixed ring 26 can be installed on the ground of the airport through a precast concrete block, or a connecting plate can be provided at the bottom of the fixed ring 26. Bolt holes are provided on the connecting plate to fix the connecting plate to the ground of the airport through bolts. By providing four fixed rings 26 which are distributed in a rectangular shape, the present disclosure enables the connecting column 20 to be located in the center of the rectangle and tethered by the two fixed rings 26 on both sides. The four fixed rings 26 can provide tightening forces in four directions, enhancing the reliability of tethering the airport mobile maintenance workstation.

In some embodiments of the present disclosure, the connecting column 20 extends in the height direction of the airport mobile maintenance workstation, and the connecting assembly further includes multiple cross bars 21, which are spaced apart on the connecting column 20. The two ends of the cross bars 21 extend in a direction away from the connecting column 20, and the connection points between the cross bars 21 and the connecting column 20 form the rope binding positions.

It can be understood that the connecting column 20 extends vertically and can be a cylindrical or prismatic structure, which can be specifically chosen depending on actual needs. A top end of the connecting column 20 can be fixed to the bottom of the airport mobile maintenance workstation by welding or bolts. The multiple spaced-apart cross bars 21 can be arranged in the length direction of the connecting column 20 itself. The cross bars 21 can be cylindrical, prismatic, or long strip-shaped plate structures. The cross bars 21 can be fixedly connected to the connecting column 20 by welding or by being inserted into through holes on the connecting column 20. The cross bars 21 can also be installed on the connecting column 20 by bolts. The cross bar 21 is connected to the connecting column 20 at the middle in its own length direction, so that both ends of the cross bar 21 protrude out of the connecting column 20. In this way, the connection point between the cross bar 21 and the connecting column 20 forms the cross-shaped rope binding position. The cross-shaped rope binding position can facilitate the sleeving connection or tightening of the tethering rope, and can also be used for wrapping the tethering rope. Therefore, the cross-shaped rope binding positions can provide multiple tying ways to fix the tethering ropes to enhance the reliability of the connection between the tethering ropes and the connecting column 20.

In some embodiments of the present disclosure, the rope unit includes a first tethering rope 22, a second tethering rope 23, and four third tethering ropes 24. Two ends of the first tethering rope 22 are connected to two rope binding positions respectively; between the two ends of the first tethering rope 22, the first tethering rope 22 is connected to two fixed rings 26 through two third tethering ropes 24 respectively. Two ends of the second tethering rope 23 are connected to two rope binding positions respectively; between the two ends of the second tethering rope 23, the second tethering rope 23 is connected to the other two fixed rings 26 through the other two third tethering ropes 24 respectively.

It can be understood that the first tethering rope 22, the second tethering rope 23, and the third tethering ropes 24 can all be ring-like rope structures, that is, two ends of one rope are connected to form a ring shape. After the first tethering rope is connected to form a ring shape, one end thereof is sleeved onto the connecting column 20 at the upper rope binding position; then, the first tethering rope is pulled out in the reverse direction from below the cross bar 21 at the upper position and passed through the fixed ring 26; the end which is passed out of the fixed ring 26 is pulled out from below the cross bar 21 at the lower position and then sleeved onto the connecting column 20 at the lower rope binding position, so that the first tethering rope can be bound to the connecting column 20 at both upper and lower positions, and the left and right sides of the first tethering rope are tightened and fixed to the ground anchors through two third tethering ropes. The second tethering rope is located on the opposite side of the first tethering rope, and the method of tying the second tethering rope is the same as that of the first tethering rope. After the second tethering rope is connected to form a ring shape, one end thereof is sleeved onto the connecting column 20 at the upper rope binding position; then, the second tethering rope is pulled out in the reverse direction from below the cross bar 21 at the upper position and passed through the fixed ring 26; the end which is passed out of the fixed ring 26 is pulled out from below the cross bar 21 at the lower position and then sleeved onto the connecting column 20 at the lower rope binding position, so that the second tethering rope can be bound to the connecting column 20 at both upper and lower positions, and the left and right sides of the second tethering rope are tightened and fixed to the ground anchors through two third tethering ropes. The first tethering rope and the second tethering rope arranged on both horizontal sides of the connecting column 20 can provide tightening forces to the connecting column 20 on both horizontal sides, and the first tethering rope and the second tethering rope can also bind the connecting column 20 at both upper and lower positions, further enhancing the reliability of the connection. In addition, by tightening the first tethering rope and the second tethering rope with two third tethering ropes, tightening forces having an angle therebetween is provided to further reliably tether the airport mobile maintenance workstation to the ground anchors.

In some embodiments of the present disclosure, the rope unit further includes two fourth tethering assemblies, each of which includes a fourth tethering rope 25 and two connecting rings 27. Two ends of the fourth tethering rope 25 are respectively connected to one of the connecting rings 27. The first tethering rope 22 is passed through the two connecting rings 27 of one of the fourth tethering assemblies respectively, and the two third tethering ropes 24 are respectively connected to one of the connecting rings 27; the second tethering rope 23 is passed through the two connecting rings 27 of the other one of the fourth tethering assemblies respectively, and the two third tethering ropes 24 are respectively connected to one of the connecting rings 27.

It can be understood that the fourth tethering rope 25 is also a ring-like structure, with two ends thereof connected to each other. After forming the ring shape, the two ends of the fourth tethering rope 25 are sleeved onto one connecting ring 27 respectively. The two connecting rings 27 are respectively connected to one third tethering rope 24 and a horizontal side of the first tethering rope 22. The above structure of connecting the two horizontal sides of the first tethering rope 22 through the fourth tethering rope 25 and connecting them to the third tethering ropes 24 enables the two horizontal sides of the first tethering rope 22 to be pulled apart in opposite directions, forming a triangle between the first tethering rope 22 and the fourth tethering rope 25, which can make the tethering structure more stable. The structure of connecting the first tethering rope 22, the third tethering ropes 24 and the fourth tethering rope 25 through the connecting rings 27 can reduce wear at the connection points of tethering ropes. Moreover, the connecting rings 27 provide a certain margin for the movement of the tethering ropes, reducing the phenomenon of mutual wear between the tethering ropes. The connecting rings 27 at the second tethering rope 23 have the same advantageous effects, which will not be described repeatedly herein.

In some embodiments of the present disclosure, the number of cross bars 21 is two. The two ends of the first tethering rope 22 are respectively wrapped around the two cross bars 21, and the two ends of the first tethering rope 22 are also wrapped around the connecting column 20. The two ends of the second tethering rope 23 are respectively wrapped around the two cross bars 21, and the two ends of the second tethering rope 23 are also wrapped around the connecting column 20.

It can be understood that the cross bars 21 can be cylindrical or prismatic, or long strip-shaped plate structures. The two ends of the cross bar 21 extend out of the connecting column 20, and upper and lower ends of the connecting column 20 are each provided with one cross bar 21. The two ends of the first tethering rope 22 are respectively connected to the cross bar 21 located at the upper end of the connecting column 20 and the cross bar 21 located at the lower end of the connecting column 20, so that the first tethering rope 22 has a tethering ability to both the upper and lower ends of the connecting column 20. By setting multiple tethering positions, the fixing ability of the aviation rope tethering device 200 to the airport maintenance mobile workstation is improved. Similarly, the two ends of the second tethering rope 23 are respectively connected to the cross bar 21 located at the upper end of the connecting column 20 and the cross bar 21 located at the lower end of the connecting column 20, so that the second tethering rope 23 has a tethering ability to both the upper and lower ends of the connecting column 20. Moreover, the second tethering rope 23 and the first tethering rope 22 are symmetrically arranged on two horizontal sides of the connecting column 20, so that the tension forces of the second tethering rope 23 and the first tethering rope 22 are balanced with each other, further improving the fixing ability of the aviation rope tethering device 200 to the airport maintenance mobile workstation.

In some embodiments of the present disclosure, at least one of the first tethering rope 22, the second tethering rope 23, the third tethering rope 24 and the fourth tethering rope 25 is provided with an adjusting member 28 for adjusting the tension of the tether.

It can be understood that the adjusting member 28 includes a ring-like buckle and an adjusting part. The ring-like buckle is a ring-like mechanism, and the tethering rope can be sleeved onto the ring-like buckle. The ring-like buckle has an opening and an opening/closing member for closing the opening. When the opening/closing member is opened, the opening is opened to facilitate the sleeving connection of the tethering rope. After the tethering rope is sleeved onto the ring-like buckle, the opening/closing member can be closed to prevent the tethering rope from coming off. The adjusting part can be a threaded mechanism. A fixed part of the adjusting part is connected to the ring-like buckle, and the other movable part is threaded with the fixed part and can move along the threads. One end of the tethering rope is connected to the ring-like buckle, and the other end of the tethering rope is connected to the movable part. By rotating the movable part, the tethering rope can be tightened or loosened. In practical use, after the first tethering rope 22, the second tethering rope 23, the third tethering rope 24, and the fourth tethering rope 25 are all connected, the adjusting member 28 can be adjusted to tighten the first tethering rope 22, the second tethering rope 23, the third tethering rope 24, and the fourth tethering rope 25, making the overall tethering structure more stable and improving the fixing ability of the aviation rope tethering device 200 to the airport mobile maintenance workstation.

In some embodiments of the present disclosure, the airport mobile maintenance workstation 100 includes: a workstation body, a wheel device 10, a trailer device 11, and an aviation rope tethering device 200. The wheel device 10 is installed at the bottom of the workstation body, and the wheel device 10 is used to make the workstation body movable; the trailer device 11 is installed at the head of the workstation body, and the trailer device 11 is used to connect to a trailer; the aviation rope tethering device 200 is the aviation rope tethering device 200 proposed according to the first aspect of the present disclosure, and the connecting column 20 of the aviation rope tethering device 200 is installed at the bottom of the workstation body.

It can be understood that the workstation body has a box structure, which can have a cubic shape; tools for aircraft maintenance and the like are arranged inside the workstation body. The wheel device 10 includes the wheels, axles, and suspension mechanisms of the airport mobile maintenance workstation 100. Four wheels can be arranged on front and rear sides of the airport mobile maintenance workstation 100 to achieve the moving function of the airport mobile maintenance workstation 100. The trailer device 11 can be a trailer hook arranged at the head of the workstation body, which can be connected to the corresponding structure on the trailer to attach the airport mobile maintenance workstation 100 to the trailer. The trailer provides power for the movement of the airport mobile maintenance workstation 100. In addition, one aviation rope tethering device 200 can be arranged at each of the front and rear sides of the workstation body to improve the effect of tethering fixation.

The airport mobile maintenance workstation 100 can be a movable workstation having aircraft maintenance tools. The aviation rope tethering device 200 proposed in the first aspect of the present disclosure can be installed at the bottom of the airport mobile maintenance workstation 100, and the aviation rope tethering device 200 can fix the airport mobile maintenance workstation 100 to the ground. The aviation rope tethering device 200 can anchor the airport mobile maintenance workstation 100 when the wind is strong, reducing the situation of the airport mobile maintenance workstation 100 accidentally sliding toward the aircraft or other facilities to cause accidental injuries.

In some embodiments of the present disclosure, the airport mobile maintenance workstation 100 further includes a support device 30, which is connected to the bottom end of the connecting column 20 and is used to support the workstation body.

It can be understood that the support device 30 can be a bracket arranged at the bottom end of the connecting column 20. Specifically, the bracket is a diamond shaped structure and has a height adjustment function. When it is necessary to move the airport mobile maintenance workstation 100 to another location, the height of the support device 30 can be adjusted to be lower than the height of the wheels, so that the airport mobile maintenance workstation 100 can move by the wheels. When the airport mobile maintenance workstation 100 is in place, the support device 30 can be adjusted to a height higher than the wheels, so that the workstation body is pressed against the support device 30. At this time, the aviation rope tethering device 200 can be operated to tether and fix the airport mobile maintenance workstation 100 to the ground of the airport. Specifically, the height of the support device 30 can be adjusted; specifically, reference can be made to existing height adjustable support structures. The specific structure of the support device 30 will not be described in detail.

A second aspect of the present disclosure proposes a fixing method for an airport mobile maintenance workstation 100, which includes the following steps:
installing a ground anchor assembly on the ground of an airport;
installing a connecting assembly at a bottom end of the airport mobile maintenance workstation 100, the connecting assembly having multiple rope binding positions arranged in a cross shape; and
wrapping two ends of tethering ropes around the multiple rope binding positions and the ground anchor assembly respectively to fix the airport mobile maintenance workstation 100.

Taking the fixation of the airport mobile maintenance workstation 100 as an example, the fixing method proposed in the second aspect of the present disclosure can anchor the airport mobile maintenance workstation 100 to the ground of the airport. This fixing method requires a simple structure, has a low cost, and can be quickly implemented. After the airport mobile maintenance workstation 100 is moved into place, the staff can fix the position of the airport mobile maintenance workstation 100 through this fixing method, reducing the accidental movement of the airport mobile maintenance workstation 100 caused by wind or other external factors, and improving the safety of the use of the airport mobile maintenance workstation 100.

Taking the fixation of the airport mobile maintenance workstation 100 as an example, specifically, the operation steps of the fixing method are as follows:
installing a ground anchor assembly on the ground of an airport;
installing a connecting assembly at a bottom end of the airport mobile maintenance workstation 100;
sleeving one end of the first tethering rope 22 to the upper rope binding position of the connecting column 20, and sleeving the other end of the first tethering rope 22 to the lower rope binding position of the connecting column 20;
sleeving two connecting rings 27 to the two horizontal sides of the first tethering rope 22 respectively, and connecting two ends of the fourth tethering rope 25 to the two connecting rings 27;
connecting two third tethering ropes 24 to the two connecting rings 27 and the ground anchors respectively to complete the tethering fixation on one side;
sleeving one end of the second tethering rope 23 to the upper rope binding position of the connecting column 20, and sleeving the other end of the second tethering rope 23 to the lower rope binding position of the connecting column 20;
sleeving two connecting rings 27 to the two horizontal sides of the second tethering rope 23 respectively, and connecting two ends of the fourth tethering rope 25 to the two connecting rings 27;
connecting two third tethering ropes 24 to the two connecting rings 27 and the ground anchors respectively to complete the tethering fixation on the other side; and
adjusting the tensioning degree of the adjusting members 28 on the tethering ropes to the tethering ropes so that the aviation rope tethering device 200 is overall tightened and the connection stability is improved.

Described above are only preferred specific embodiments of the present disclosure, but the scope of protection of the present disclosure is not limited to this. Any changes or replacements that can be easily conceived by those skilled in the art within the technical scope disclosed by the present disclosure should be covered within the scope of protection of the present disclosure. Therefore, the scope of protection of the present disclosure should be accorded with the scope of protection of the claims.

1. An aviation rope tethering device, characterized by comprising:
a ground anchor assembly, which is used for installation on the ground of an airport;
a connecting assembly, which comprises a connecting column having multiple rope binding positions spaced apart in a length direction of the connecting column, one end of the connecting column being used to connect to one of an airport mobile maintenance workstation, an aviation trailer and an aircraft; and
a rope unit, which is connected to at least one of the rope binding positions, the connecting column being connected to the ground anchor assembly through the rope unit.

2. The aviation rope tethering device according to claim 1, wherein the ground anchor assembly comprises four fixed rings distributed in a rectangular shape, two of which are provided on one side of the connecting column in a horizontal direction, and the other two of which are provided on the other side of the connecting column in the horizontal direction.

3. The aviation rope tethering device according to claim 2, wherein the connecting column extends in a height direction of the airport mobile maintenance workstation, and the connecting assembly further comprises multiple cross bars spaced apart on the connecting column; two ends of the cross bars extend in a direction away from the connecting column, and the rope binding positions are formed at the connection points between the cross bars and the connecting column.

4. The aviation rope tethering device according to claim 3, wherein the rope unit comprises a first tethering rope, a second tethering rope, and four third tethering ropes; two ends of the first tethering rope are respectively connected to two of the rope binding positions, and between the two ends of the first tethering rope, the first tethering rope is connected to two of the fixed rings respectively through two of the third tethering ropes; two ends of the second tethering rope are respectively connected to two of the rope binding positions, and between the two ends of the second tethering rope, the second tethering rope is connected to the other two fixed rings respectively through the other two third tethering ropes.

5. The aviation rope tethering device according to claim 4, wherein the rope unit further comprises two fourth tethering assemblies, each of which comprises a fourth tethering rope and two connecting rings; two ends of the fourth tethering rope are respectively connected to one of the connecting rings; the first tethering rope passes through the two connecting rings of one of the fourth tethering assemblies respectively, and the two third tethering ropes are respectively connected to one of the connecting rings; the second tethering rope passes through the two connecting rings of the other one of the fourth tethering assemblies respectively, and the two third tethering ropes are respectively connected to one of the connecting rings.

6. The aviation rope tethering device according to claim 5, wherein the number of the cross bars is two; the two ends of the first tethering rope are respectively wrapped around the two cross bars, and the two ends of the first tethering rope are also wrapped around the connecting column; the two ends of the second tethering rope are respectively wrapped around the two cross bars, and the two ends of the second tethering rope are also wrapped around the connecting column.

7. The aviation rope tethering device according to claim 6, wherein at least one of the first tethering rope, the second tethering rope, the third tethering rope and the fourth tethering rope is provided with an adjusting member for adjusting the tensioning degree of the tethering rope.

8. The aviation rope tethering device according to claim 1, wherein the airport mobile maintenance workstation further comprises a support device, which is connected to a bottom end of the connecting column, and which is used to support one of the airport mobile maintenance workstation, the aviation trailer, and the aircraft.

9. The aviation rope tethering device according to claim 8, wherein a support height of the support device is adjustable.

10. A fixing method, which is implemented by the aviation rope tethering device according to claim 1, comprising:
installing a ground anchor assembly on the ground of an airport;
installing a connecting assembly at a bottom end of the airport mobile maintenance workstation, the connecting assembly having multiple rope binding positions arranged in a cross shape; and
wrapping two ends of tethering ropes around the multiple rope binding positions and the ground anchor assembly respectively to fix the airport mobile maintenance workstation.
